(19) United States
(12) Patent Application Publication
(10) Pub. No.: US 2005/0199139 A1
(43) Pub. Date: Sep. 15, 2005

(54) Method and apparatus for washing cored produce

(75) Inventor: Robert T. Elliot, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fresh Express, Inc., Salinas, CA (US)

(21) Appl. No.: 10/412,728

(22) Filed: Apr. 10, 2003

Related U.S. Application Data
(60) Provisional application No. 60/372,213, filed on Apr. 10, 2002.

(51) Int. Cl. B02B 3/12

(52) U.S. Cl. 99/536

(57) ABSTRACT

An apparatus for washing a cored head of a leafy vegetable or a coreable vegetable including a support, a head holder and a release. The support includes a support mount for mounting the apparatus adjacent a conveyor and a support frame extending from the support mount. The head holder is pivotally connected to the support frame and movable between a first support position and a second release position. The holder is adapted to support a cored head of a vegetable when in the support position. The holder has an opening sufficiently large to permit a wash spray to project through the opening for washing the cored head. The release is affixed to the head holder, whereby moving the release moves the holder from the first support position to the second release position thus allowing displacement by gravity of the cored head onto the conveyor. A method of washing a cored head is also described.

### CROSS-REFERENCES TO RELATED APPLICATIONS

This application claims priority to U.S. Provisional Application No. 60/372,213 filed Apr. 10, 2002 which is herein incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to a new and improved method and apparatus for washing a cored head of a leafy vegetable or other coreable vegetables or produce.

2. Description of Related Art

Examples of apparatus disclosed in the prior art generally include a perforated platform connected to and supporting a tripod, or other vegetable head guide, that fits into the core hole of a cored vegetable head, and orients the cored head during washing of the core hole. The guide includes three L-shaped vanes that project upwardly from the support platform.

The platform includes supports for a cored head holder. The holder has an opening sufficiently large to permit the guide to project through the opening with the holder in a first position over the guide. The opening in the holder includes, near the top of the holder, a recess, preferably of sufficient size and shape to receive and support a cored head. In a first position, a core hole of the cored head is placed over the guide and into the recess of the holder, with the cored head otherwise resting in the recess of the holder.

The holder is pivotally connected to two holder supports. The two holder supports are connected to the support platform so that the holder can move upwardly from the first, horizontal position, where the guide projects through the opening in the holder, to a second raised position at a distance of 45° to 75° from the first position. This movement to a second position unseats the cored area of the head from the guide and propels the head onto a conveyor that carries the cored, washed head from the washing apparatus.

Disadvantageously, such a holder disclosed in the prior art pushes the head to unseat the cored area of the head from the guide and propel the head onto the conveyer. Such a pushing configuration applies an amount of force against the head that may be sufficient to bruise or otherwise damage the head. Moreover, reliance on such an elaborate mechanical device to accomplish a relatively simple physical task may be impractical, particularly for field harvesting operations, and may decrease the productivity and efficiency of field workers by forcing them to work at the pace of the machine.

The prior art also discloses a housing forming a chamber that stores and dispenses aqueous, head washing solution. Inside this chamber is an inlet valve through which such a solution enters the chamber. This inlet valve is connected to a float mechanism. The inlet valve maintains a predetermined, adjustable level, usually at or near the middle of the chamber.

Inside the chamber are a screen and screen housing through which the aqueous solution exits the chamber and flows, via lines and valves, into a pressurizable chamber. At least one valve is a check valve that prevents the aqueous solution from escaping the pressurized chamber, and flowing upstream toward the screen and screen housing. Inside the pressurized chamber is a siphon with an opening at a distal end near the bottom of the pressurizable chamber. Aqueous solution enters the siphon from this distal end, and flows, under pressure, upwardly toward a nozzle at the proximal end of the siphon. The pressurized chamber also includes an opening for admitting a pressurizing gas such as air into tile chamber. The prior art also discloses that the nozzle at the proximal end of the siphon discharges a spray of aqueous solution upwardly into and through the area within the guide, and into and around the cored area of a head to wash the head efficiently.

Disadvantageously, the chambers described in the prior art rely on a complex pressurizing system, which may be relatively costly to manufacture and maintain. This same pressurizing system also serves a timing function and provides force for the various mechanical elements which manipulate the head, adding further complexity and making the device impractical for some operations.

What is needed is a method and apparatus for washing a cored head that overcomes the above and other disadvantages of the prior art. In particular, what is needed is a method and apparatus for cleaning cored heads that is capable of accommodating the extreme wear and tear conditions found in field harvesting operations. Further, such an invention should enhance worker efficiency and productivity.

### SUMMARY OF THE INVENTION

In summary, one aspect of the present invention is directed to an apparatus for washing a cored head of a leafy vegetable or coreable vegetable, such as, for example, lettuce, spinach, cabbage, baby leaves, baby lettuce, baby spinach, frisee, flowering kale, kale, cilantro, baby leaf vegetables, arugula, etc. The apparatus generally includes a support, a head holder and a release. The support includes a support mount for mounting the apparatus adjacent a conveyor and a support frame extending from the support mount. The head holder is pivotally connected to the support frame and movable between a first support position and a second release position. The head holder is adapted to support a cored head of a leafy vegetable when in the support position. The holder has an opening sufficiently large to permit a wash spray to project through the opening for washing the cored head. The release is affixed to the head holder, whereby moving the release pivots the holder from the first support position to the second release position, thus allowing displacement by gravity of the cored head onto the conveyor.

In accordance with one aspect of the present invention, the apparatus includes a spring for biasing the head holder in the first support position. Preferably, the apparatus includes a wash spray nozzle directed toward the opening. The wash spray nozzle may direct the wash spray substantially exclusively into a cored hole of the cored head of the vegetable. The wash spray nozzle may be mounted on the support mount. Preferably, the head holder includes a support ring that extends in a substantially horizontal plane when the holder is in the first support position and in an inclined plane when in the second release position.

Another aspect of the present invention is directed to a method of washing a cored head including the steps of placing a cored head on a head holder in a first support position, directing a spray against the cored head to prepare the cored head, and moving the head holder from the first support position to a second release position to allow the cored head to displace by gravity from the head holder onto the conveyor. The head holder is located adjacent a conveyor.

Preferably, the moving step is accomplished by pulling a release lever affixed to the head holder to pivot the head holder from the first support position to the second release position. Preferably, the moving step allows the cored head to roll under the force of gravity from the head holder onto the conveyor.

Accordingly, the present invention provides a method and apparatus that diminishes the force applied to the cored vegetable head in translating the head from a wash station to a conveyor. Additionally, the present invention provides an apparatus that has a simplified and more practical design.

The method and apparatus for washing a cored head in accordance with the present invention has other features and advantages which will be apparent from or are set forth in more detail in the accompanying drawings, which are incorporated in and form a part of this specification, and the following Detailed Description of Exemplary Embodiments of the Invention, which together serve to explain the principles of the present invention.

### BRIEF DESCRIPTION OF THE DRAWINGS

FIG. 1 is a perspective view of an apparatus for washing a cored vegetable head in accordance with the present invention, the apparatus mounted adjacent a conveyor and shown supporting a cored head in a first support position.

FIG. 2 is a perspective view of the apparatus of FIG. 1 with the cored head and the conveyor removed, a head holder of the apparatus shown in the first support position.

FIG. 3 is a perspective view, similar to FIG. 2, of the apparatus of FIG. 1, the head holder shown in a second release position.

FIG. 4 is an enlarged side view of a portion of the apparatus shown in FIG. 1 illustrating a coupler pipe mount affixed to a support mount of the apparatus.

FIG. 5 is a perspective view of an alternative apparatus for washing a cored vegetable head in accordance with the present invention.

### DETAILED DESCRIPTION OF EXEMPLARY EMBODIMENTS OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

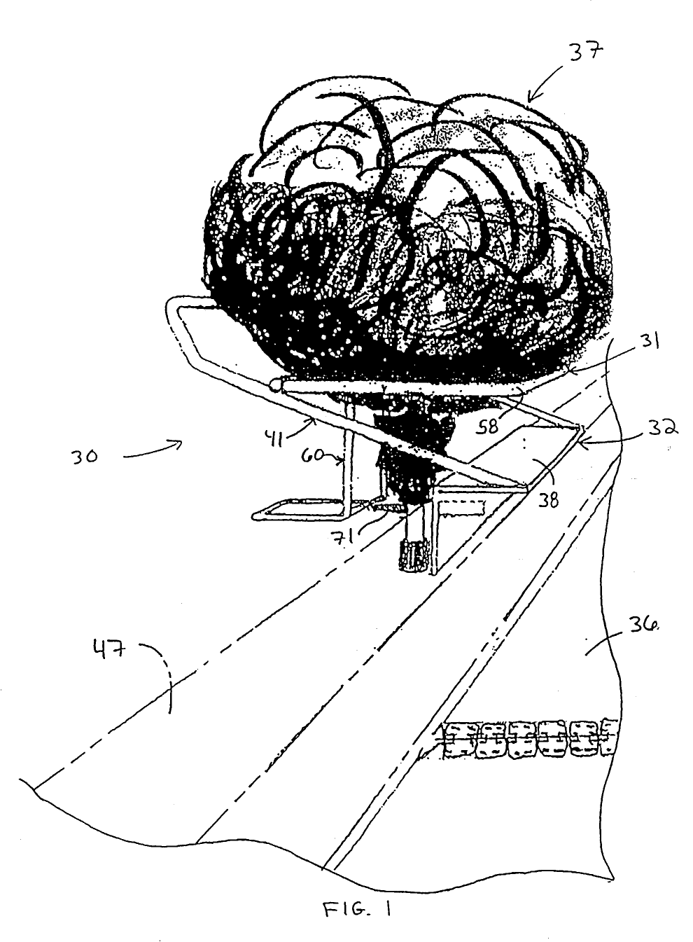

Turning now to the drawings, wherein like components are designated by like reference numerals throughout the various figures, attention is directed to FIG. 1 which shows an apparatus 30 for washing a cored head of a leafy vegetable or a coreable vegetable or produce (which may include fruit) in accordance with the present invention. In preferred embodiments, the present invention is especially useful for washing cored heads of leafy vegetables, such as, for example, lettuce, spinach, cabbage, baby leaves, baby lettuce, baby spinach, frisee, flowering kale, kale, cilantro, baby leaf vegetables, arugula, etc. Apparatus 30 generally includes a head holder 31 pivotally mounted on a support 32. Support 32 is dimensioned and configured for mounting apparatus 30 adjacent a conveyor 36 of the type generally used while harvesting coreable vegetables in a well known manner. Holder 31 is dimensioned and configured to pivot between a first support position, in which the holder can support a head of a coreable vegetable 37 for washing the head, and a second release position, in which head 37 is gravity released such that it is displaced onto conveyor 36.

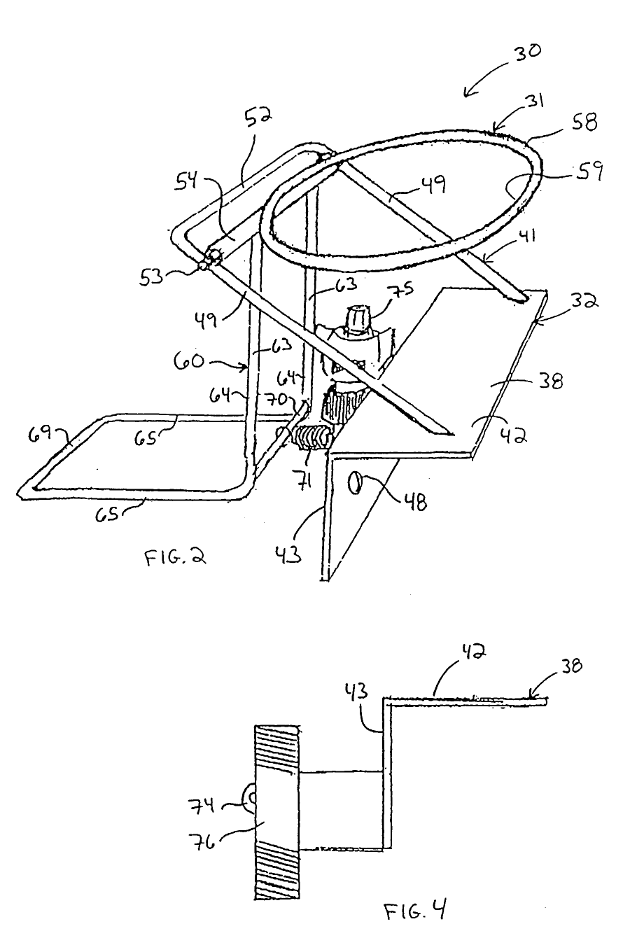

In one embodiment shown in FIG. 1, support 32 includes a support mount 38 and a support frame 41. In the illustrated embodiment, support mount 38 is in the form of an angle iron having a top 42 and a side 43. Support mount 38 is attached to a conveyor frame 47 in a well known manner. For example, support mount 38 can be provided with one or more apertures 48, as shown in FIG. 2, though which a threaded fastener extends to releasably secure support mount 38 to conveyor frame 47. One should appreciate that the particular means for mounting the support mount adjacent the conveyor can vary widely within the scope of the present invention. For example, the support mount can be welded directly to a conveyor frame or other object securing the mount adjacent and with respect to the conveyor.

As most clearly shown in FIG. 2, support frame 41 extends upwardly and outwardly from support mount 38 to position holder 31, and any head 37 supported thereon, above and slightly to one side of conveyor 36. In the illustrated embodiment, support frame 41 includes two side support rails 49 which extend upwardly and outwardly at an angle with respect to support mount 38. Side rails 49 are interconnected by a transverse support rail 52. A pivot axis 53 is mounted on side rails 49 such that pivot axis is substantially parallel to the direction of travel of conveyor 36. One should appreciate, however, that the pivot axis need not be parallel to the conveyor. For example, the pivot axis may be angled with respect to the direction of travel in order to impart an initial velocity of the head with respect to the speed of travel of the conveyor.

Preferably, side rails 49 extend of an angle between approximately 30° and 60° and preferably approximately 45° in order to position holder 31 and head 37 such that the head will be subjected to minimal impact when head 37 is released onto conveyor 36. One should appreciate that the configuration and angle of the side rails may widely vary in accordance with the present invention. For example, the angle of the side rails may be greater than 60° or less than 30°. Furthermore, one or more support plates can be used instead of rails to position the pivot axis above and to one side of the conveyor in accordance with the present invention.

Suitable materials for support 32 include, but are not limited to, steel, alloys, plastics and other materials suitable for use in harvesting and agricultural environments. For example, support mount 38 may be fabricated from two inch angle iron and side support rails 49 may be formed of ¼ or 5/16 inch rod stock welded thereto. Pivot axis 53 may similarly be formed of ⅜ inch rod stock welded to side support rails 49.

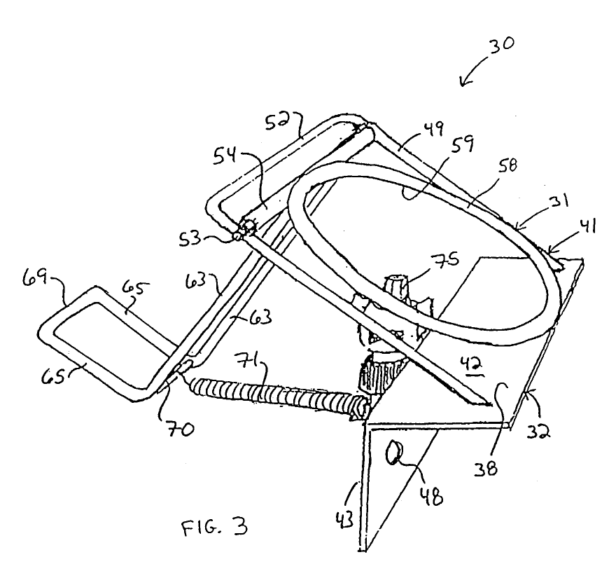

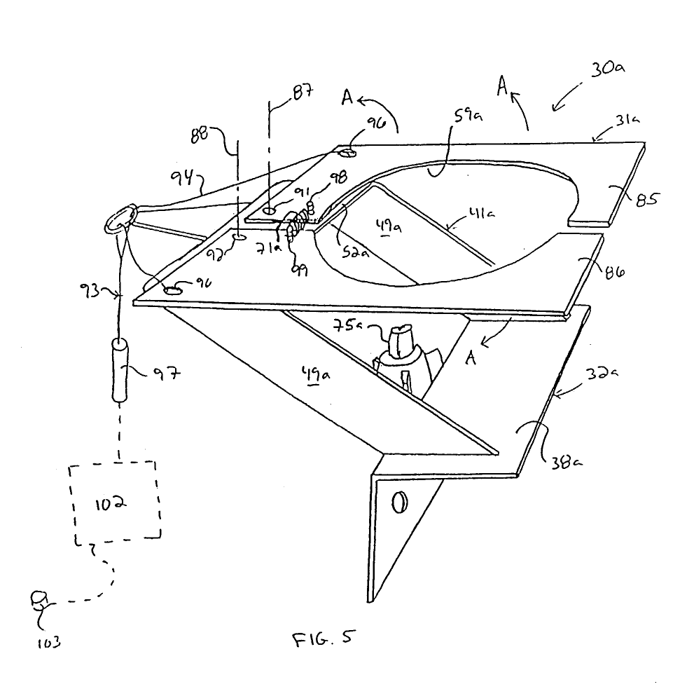

In the illustrated embodiment, head holder 31 is pivotally mounted on pivot axis 53 of support 32 such that it can pivot between a first support position, as shown in FIG. 2, and a second release position, as shown in FIG. 3. In particular, holder 31 includes a tubular pivot member 54 pivotally mounted about pivot axis 53 of support 32. A holder ring 58 is rigidly secured to pivot member 54 extends toward conveyor 36. Holder ring 58 includes an opening 59 which allows washing of the core area of head 37 while supported in the first support position. As shown in FIG. 2, ring 58 extends in a substantially horizontal plane when holder 31 is in the first support position. One should appreciate that the holder ring need not be horizontal provided it supports a cored head such that the head does not roll off the holder ring during washing.

A release lever 60 is rigidly secured to head holder 31 for pivoting holder 31 from the first support position of FIG. 2 to the second release position of FIG. 3. Release lever 60 includes a pair of release members 63 having substantially vertical portions 64 thereof extending downwardly from tubular pivot member 54 of holder 31 and substantially horizontal portions 65 thereof extending outwardly from lower ends of the vertical portions. The outer ends of horizontal portions 65 of release members 63 are interconnected by all outer transverse release member 69 and the inner ends are interconnected by all inner transverse release member 70. One should appreciate that configuration of the release lever can vary widely in accordance with the present invention, provided that the release lever provide a means for an operator to move the head holder from its first support position to its second release position.

Suitable materials for head holder 31 and release lever 60 also include, but are not limited to, steel, alloys, plastics and other materials suitable for use in harvesting and agricultural environments. For example, ¼ or 5/16 inch rod stock may be used to fabricate the majority of holder 31 and lever 60. Tubular pivot member 54 may be formed of ⅜ inch pipe stock.

In the embodiment illustrated in FIGS. 2 and 3, head holder 31 is biased toward the first support position by a spring 71. One end of spring 71 is affixed to an eyelet 74 that is mounted on support 32. The opposite end of spring 71 is affixed to inner transverse release member 70 of release lever 60. The configuration of spring 71 biases release lever 60 toward support 32 and thus biases holder 31 toward the first support position. One should appreciate that other means to bias the head holder 31 to the first support position can be used in accordance with the present invention. For example, the head holder may have an over center type configuration in which the force of gravity biases the release lever toward the support.

A spray wash nozzle 75 is positioned between release lever 60 and support mount 38 for washing the core area of head 37 when it is supported by head holder 31 in the first support position. In particular, nozzle 75 is positioned such that a wash spray is directed upwardly through opening 59 of holder ring 59, as shown in FIG. 2. In the illustrated embodiment, nozzle 75 is threadably mounted on an upper end of a coupler pipe 76. Similarly, a wash spray supply line 80 threadably engages a lower end of coupler pipe 76 to supply a wash solution to nozzle 75 that is suitable for washing and/or otherwise processing a cored head supported by the holder ring. In the illustrated embodiment, eyelet 74 is mounted on coupler pipe 76 which, in turn, is rigidly affixed to side 43 of support mount 38. One should appreciate that a coupler pipe need not be used. Instead, a suitable positioning device or stand can be used to properly position the spray wash nozzle such that it directs a wash spray toward the core area of the cored head. In the case that a coupler pipe is not used, the eyelet could be mounted directly on the support mount.

Spray wash nozzle 75 may be configured so that it may extend into the core area of head 37 if it is so desired. There are many suitable ways to accomplish this. For example, a stepper motor may be coupled to the nozzle or the coupler pipe to move it in and out of the core area. In such an embodiment, coupler pipe 76 may be pivotally affixed to side 43 as opposed to rigidly. Alternatively, coupler pipe 76 may comprise an elastic material that may be stretched or expanded and retracted. Additionally, apparatus 30 or appropriate portions thereof may be configured to be moveable so that it may be moved to move the cored head into position so that spray nozzle 75 may extend into the core area and may be removed therefrom. Those skilled in the art will understand that there are other ways to extend spray nozzle into the core area.

In operation and use, a worker cores a head 37 in a well known manner and manually places the cored head upon head holder 31 such that the core head 37 faces downward and is coincident with opening 59. As the force of spring 71 is sufficient to overcome the weight of head 37, the head holder 31 supports head 37 in the first support position as shown in FIGS. 1 and 2. In this position, spray wash nozzle 75 directs a wash spray upward and into the recess to wash and/or otherwise prepare cored head 37. Preferably, a constant stream of wash spray is emitted from nozzle 75, however, one should appreciate that the stream need not be constant. For example, the worker can manually activate the wash spray or the wash spray may be activated by a timer in a well known manner. While cored head 37 is being washed and/or otherwise prepared, the worker may core a subsequent head.

Once cored head 37 is sufficiently washed, and the worker has a subsequent cored head to be washed, the worker moves release lever 60 to move head holder 31 to its second release position, as shown in FIG. 3. In the release position, the force of gravity causes the head to roll or otherwise displace from holder 31 and onto conveyor 36. Next, the worker releases lever 60, thus allowing spring 70 to bias holder 31 back to the first support position. Now the worker may repeat the process on the subsequent cored head and so on.

One should appreciate that multiple apparatuses 30 can be provided on a single conveyor to provide a dedicated washing station for each of a number of workers.

Advantageously, the apparatus for washing a cored head in accordance with the present invention has a simple configuration that is easily and inexpensively fabricated. Furthermore, the simplified configuration requires minimal maintenance.

Advantageously, the configuration of the present invention also subjects cored heads to minimal handling forces which may bruise or otherwise damage the cored heads. As pulling the release lever causes a cored head to roll or otherwise displace from the head holder, there is no need for a worker to strike or knock the head from the holder onto the conveyor. Similarly, no mechanical structure that pushes or propels the head from the holder onto the conveyor is necessary.

In another embodiment of the present invention shown in FIG. 5, apparatus 304 is similar to apparatus 30 described above but includes a head holder 31 a having a pair of holder arms 85 and 86 which support a cored head for washing instead of holder ring 58, described above. Like reference numerals have been used to describe like components of apparatus 30 and apparatus 30a.

Apparatus 30a generally includes head holder 31a mounted on a support 32a. Similar to support 32 discussed above, support 32a is dimensioned and configured for mounting apparatus 30a adjacent a conveyor. Holder 31a includes the pair of holder arms 85 and 86 which are dimensioned and configured to pivot between a first support position and a second release position. In the first position shown in FIG. 5, the holder arms can support a cored head for washing the head. Each holder arm 85, 86 can pivot in the direction of arrows A about a respective axis 87, 88 to the second release position in which the holder 31a releases the head such that it is displaced onto the conveyor by the force of gravity.

In the embodiment shown in FIG. 5, support 32a includes a support mount 38aand a support frame 41a. Support mount 38a is attached to the conveyor frame in a well known manner. Support frame 41a extends upwardly and outwardly from support mount 38ato position holder 31a, and any cored head supported thereon, above and slightly to one side of the conveyor. In the illustrated embodiment, support frame 41a includes two side support plates 49a which extend inwardly and outwardly at an angle with respect to support mount 38a. Side plates 49a are interconnected by a transverse support plate 52a.

In the illustrated embodiment, head holder 31a includes two holder arms 85 and 86 which are pivotally mounted on support 32a such that each holder arm can pivot about axes 87 and 88, respectively, between a first support position, as shown in FIG. 5, and a second release position. In particular, each holder arm includes a pivot member 91 and 92, respectively, pivotally mounting the holder arms to transverse support plate 52a in a well known manner.

Each holder arm 85, 86 includes a semicircular recess that, together, form an opening 59a which allows washing of the core area of the head while supported in the first support position. As shown in FIG. 2, holder arms 85 and 86 extend in a substantially horizontal plane when holder 31a is in the first support position.

A release line 93 is secured to each holder arm 85, 86 for pivoting the holder arms from the first support position of FIG. 5 to the second release position. Release line 93 includes a pair of diverging portions, each having an end which extends through a respective release line aperture 96 for securing release line 93 to the holder arms in a well known manner. The opposite end of release line 93 is attached to a release handle 97. One should appreciate that configuration of the release line can vary widely in accordance with the present invention, provided that the release line provides a means for an operator to move the head holder from its first support position to its second release position.

In the embodiment illustrated in FIG. 5, holder arms 85 and 86 of head holder 31a are biased toward the first support position by a spring 71a. One end of spring 71a is affixed to a first pin 98 that is mounted on holder arm 85. The opposite end of spring 71a is affixed to a second pin 99 that is mounted on holder arm 86. The configuration of spring 71a biases the holder arms toward one another and thus biases holder 31a toward the first support position. One should appreciate that other means to bias the head holder 31a to the first support position can be used in accordance with the present invention.

A spray wash nozzle 75a is positioned adjacent support mount 38a for washing the core area of the cored head when it is supported by head holder 31a in the first support position. In particular, nozzle 75a is positioned such that a wash spray is directed upwardly through opening 59a, as shown in FIG. 5.

In operation and use, apparatus 30a is used in substantially the same manner as apparatus 30 discussed above. A worker cores a head of produce in a well known manner and manually places the cored head upon head holder 31a such that the core recess of the head faces downward and is coincident with opening 59a. In this position, spray wash nozzle 75a directs a wash spray upward and into the recess to wash and/or otherwise prepare the cored head. While the produce heart is being washed and/or otherwise prepared, the worker may core a subsequent head of produce.

Once the head is sufficiently washed, and the worker has a subsequent cored head to be washed, the worker moves release handle 97 to move holder arms 85 and 86 apart and in the direction of arrows A to the second release position. With the holder arms in the spread-apart release position, the force of gravity causes the cored head to fall or otherwise displace between the holder arms and roll along support plates 49a onto the conveyor. Next, the worker releases release handle lever 97, thus allowing spring 70a to bias holder arms 85 and 86 back to the first support position. Now the worker may repeat the process on the subsequent cored head and so on.

One should appreciate that apparatus for washing a cored head of produce may be automated in accordance with the present invention. For example, in one embodiment, release line 97 may be operably connected in a well known manner to an electromechanical actuator 102, as shown in phantom in FIG. 5. Actuator 102 can be controlled by a foot switch 103 which the worker steps on to pull release line 93 and thus release line 93 and thus release a cored head from head holder 31a. Alternatively, actuator 102 may be controlled by a timer in which a cored head is automatically released front holder 31a after a predetermined period or interval of time.

One should appreciate that a wide variety of automation means can be used for moving release line 93 of apparatus 30a to automatically release a head from holder 31a. Similarly, one should appreciate that a wide variety of automation means can be provided to move the release lever 60 of apparatus 30 to automatically release a head from holder 31 in accordance with the present invention. One should also appreciate that an automation activator can also be operatively connected directly to holder 31 or 31a in order to effect movement between the support and release positions.

For convenience in explanation and accurate definition in the appended claims, the terms “up” or “upper”, “down” or “lower”, “inside” and “outside” are used to describe features of the present invention with reference to the positions of such features as displayed in the figures.

In many respects the modifications of the various figures resemble those of preceding modifications and the same reference numerals followed by the subscript a designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. An apparatus for washing a cored head of produce comprising:
a support including a support mount for mounting the apparatus adjacent a conveyor and a support frame extending from the support mount;
a head holder pivotally connected to the support frame and movable between a first support position and a second release position, the head holder adapted to support a cored head when in the support position, the holder having an opening sufficiently large to permit a wash spray to project through the opening for washing the cored head;
a release affixed to the head holder, whereby moving the release moves the holder from the first support position to the second release position allowing displacement by gravity of the cored head from the holder.

2. The apparatus of claim 1 further comprising a biasing member for biasing the head holder in the first support position.

3. The apparatus of claim 2 wherein the biasing member is a spring.

4. The apparatus of claim 1 further comprising a wash spray nozzle directed toward the opening.

5. The apparatus of claim 4 wherein the wash spray nozzle is adapted to direct the wash spray substantially exclusively into a cored area of the cored head supported by the head holder.

6. The apparatus of claim 4 wherein the wash spray nozzle is mounted on the support mount.

7. The apparatus of claim 1 wherein the head holder comprises a support ring extending in a substantially horizontal plane when the holder is in the first support position.

8. The apparatus of claim 6 wherein the support ring extends in an inclined plane when in the second release position.

9. The apparatus of claim 4 wherein the wash spray nozzle is positioned outside a cored area of cored head.

10. The apparatus of claim 4 wherein the wash spray nozzle is positioned such that at least a portion of the wash spray nozzle extends into a cored area of cored head.

11. A method of washing a cored head of produce comprising the steps of:
placing a cored head on a head holder in a first support position, the head holder located adjacent a conveyor;
directing a spray against the cored head to process the cored head; and
moving the head holder downwardly from the first support position to a second release position releasing the cored head onto the conveyor.

12. The method of claim 11 wherein the moving step is accomplished by moving a release lever affixed to the head holder.

13. The method of claim 12 wherein the moving step is accomplished by pulling a release lever affixed to the head holder to pivot the head holder from the first support position to the second release position.

14. The method of claim 11 wherein the moving step allows the head to roll under the force of gravity from the head holder onto the conveyor.
